(19) United States
(12) Patent Application Publication
(10) Pub. No.: US 2020/0234396 A1
(43) Pub. Date: Jul. 23, 2020

(54) HETEROGENEOUS COMPUTATION AND HIERARCHICAL MEMORY IMAGE SENSING PIPELINE

(71) Applicant: Black Sesame International Holding Limited, Santa Clara, CA (US)

(72) Inventors: Zheng Qi, Cupertino, CA (US); Qun Gu, San Jose, CA (US); Chengyu Xiong, San Jose, CA (US)

(73) Assignee: Black Sesame International Holding Limited

(21) Appl. No.: 16/381,692

(22) Filed: Apr. 11, 2019

Related U.S. Application Data
(60) Provisional application No. 62/795,405, filed on Jan. 22, 2019.

(51) Int. Cl. G06T 1/60; G06T 1/20; G06F 12/02; G06F 12/128; G06T 1/00

(52) U.S. Cl. CPC G06T 1/60; G06T 1/20; G06F 12/0246; G06F 12/128; G06T 1/0014; G06F 12/0207

(57) ABSTRACT

A system on a chip, including a multi-port memory controller having a multi-level memory hierarchy, a multi-tier bus coupled to the multi-port memory controller to segregate memory access traffic based on the multi-level memory hierarchy, an interconnected plurality of networks on chip coupled to the multi-tier bus, a plurality of networked domains coupled to the plurality of networks on chip and at least one non-networked domain coupled directly to the multi-port memory controller.

### BACKGROUND

### Technical Field

The instant disclosure is related to an architecture and dataflow for a system on a chip utilized in image sensing for autonomous driving applications.

### Background

The instant disclosure describes a system-on-chip (SoC) architecture and data flow. Image sensing pipelines have become a central sub-system in autonomous driving system-on-chip (SoC) platforms. Conditional automation level 3 (L3) and above autonomous driving systems have sensing pipelines that are continually aware and highly reliable. Level 3 allows a driver to shift safety critical functions to the vehicle. This L3 image sensing pipeline needs to support multiple sensors and utilizes multiple data processing methods to ensure redundancy and accuracy.

Image sensor inputs have increased from historically supporting one or two sensors at video graphics array (VGA) or 720p resolution at 30 frames per second (FPS) to currently supporting multiple 1080p or 4K sensors at 60 frames per second.

Image analysis needs to support low-light and high dynamic range (HDR) for driving conditions such as night vision, image analysis in tunnels, in and facing the sun, foggy or rainy weather and the like.

The sensing pipeline needs to support the detection of small objects at distances of over 100 meters. These current needs necessitate sophisticated and high-performance data processing algorithms that are computation and memory bandwidth intensive.

By way of comparison current smart phones have the ability to process data at sub ten giga operations per second (GOPS), whereas a typically automated driving system demands 20-50 terra operations per second (TOPS), in essence, over a thousand times higher computation demand.

Historically the sensing pipeline utilized the discrete processing steps of sensing, image signal processor, computer vision (CV) and artificial intelligence (AI) processing. This multi-chip solution had processing steps operate in isolation. Steps may receive active feedback from other steps to allow for adaptive processing which necessitates tighter coupling of the steps. For example, the image signal processor may adjust sensing parameters based on feedback from neural network detection result statistics. Additionally, computer vision (CV) processing may be coupled with different stages of the network architecture to provide feed forward or feedback data to other parts of the system.

Current, the computation for automated driving systems (ADS) calls for high performance and bandwidth as well as sophisticated processing controls. The performance needs of ADS in turn necessitates that the sensing pipelines utilize more complex algorithms to provide real-time processing under power-consumption constraints. The instant disclosure discloses an SoC system to provide possible solutions for these enhanced computational needs.

### SUMMARY

A first example system on a chip, including at least one of a multi-port memory controller having a multi-level memory hierarchy, a multi-tier bus coupled to the multi-port memory controller to segregate memory access traffic based on the multi-level memory hierarchy, an interconnected plurality of networks on chip coupled to the multi-tier bus, a plurality of networked domains coupled to the plurality of networks on chip and at least one non-networked domain coupled directly to the multi-port memory controller.

A second example system on a chip, including at least one of a multi-port memory controller, a multi-tier bus coupled to the multi-port memory controller utilizing a multi-level memory hierarchy, a plurality of interconnected networked domains coupled to the multi-tier bus, wherein memory access to the plurality of interconnected networked domains is controlled via a multi-tier bus hierarchy based on the multi-level memory hierarchy via the multi-port memory controller, at least one non-networked domain directly connected to the multi-port memory controller, the at least one non-networked domain receives a plurality of raw sensor data streams in the at least one non-networked domain, a plurality of signal processors that resolves the plurality of raw sensor data streams into a plurality of processed sensor data, at least one sensor data memory that stores the plurality of processed sensor data via the multi-port memory controller, at least one central processor unit that analyzes the plurality of processed sensor data, at least one central data memory that stores at least one result of the analysis via the multi-tier bus hierarchy based on the multi-level memory hierarchy and an output interface that outputs at least one of a human readable data and a machine actionable data.

A third example method of signal processing, including at least one of partitioning memory access of a plurality of interconnected networked domains and at least one non-networked domain into a multi-level memory hierarchy, controlling memory access to the plurality of interconnected networked domains via a multi-tier bus hierarchy based on the multi-level memory hierarchy via a multi-port memory controller, controlling memory access to the at least one non-networked domain via direct memory access to the multi-port memory controller, receiving a plurality of raw sensor data streams in the at least one non-networked domain, resolving the plurality of raw sensor data streams to a plurality of processed sensor data by a plurality of signal processors, storing the plurality of processed sensor data in a plurality of sensor data memories via the multi-port memory controller, receiving the plurality of processed sensor data from the plurality of sensor data memories by at least one of the plurality of interconnected networked domains through the multi-tier bus hierarchy based on the multi-level memory hierarchy, analyzing the plurality of processed sensor data in at least one central processor unit and outputting a result of the analysis to at least one of a human readable data and a machine actionable data.

### DESCRIPTION OF THE DRAWINGS

In the drawings:

FIG. 1 is a first example system diagram in accordance with one embodiment of the disclosure;

FIG. 2 is a second example system diagram in accordance with one embodiment of the disclosure; and

FIG. 3 is an example method of signal processing in accordance with one embodiment of the disclosure.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

End-to-End High-Performance Pipeline

The disclosed architecture includes an end-to-end image processing pipeline that may be flexibly configured to support multiple sensor streams. In one example embodiment the number of sensor streams is twelve. The sensor streams may be directly processed by the centralized image signal processors as inline processing or be stored into random access memory then processed in store-n-forward processing.

In the case of inline processing, the image may be temporarily buffered by on-chip bit stream memory. The buffering allows subsequent de-noise, interpolation, and the like.

In case of store-n-forward processing, multiple exposure frames of the sensor may be combined to form a high dynamic resolution (HIDR) frame. The store-n-forward processing case also allows image signal processors to be bypassed for sensor streams in which the image signal processor is integrated with the image sensor.

The end-to-end pipeline also allows stream processing of the video frames using a combination of computer vision functions such as stereo, pyramid, optical flow and neural network functions for detection, segmentation and classification. After processing, the video stream may be encoded for storage and re-transmission over the network.

The block streaming memory (BSMEM, mostly for 2-D image block streaming transfer) and block tensor memory (BTMEM, mostly for 3-D neural network tensor block transfer) are integrated in the flexible end-to-end processing pipeline. These modules serve as on-chip shared memory for efficient inline data transfer, as well as shared direct memory access (DMA) agents for different engines to be able to access random access memory off-chip for data storage. The modules track data access requests as intelligent cache agents to maximize the utilization of on-chip random access memory (RAM) and minimize the number of random memory access requests. In cases where random access memory (RAM) access is called for, the modules to perform the access efficiently by combining requests, read data pre-fetching and write data coalescing.

Heterogeneous Computation

The architecture deploys diversified types of computation resources.

At the application level, the architecture deploys multiple ARM A-class central processing units (CPUs) constructed as big.LITTLE architecture. ARM big.LITTLE is a heterogeneous computing architecture, linking less powerful processor cores (LITTLE) with more powerful processor cores (big). Both sets of cores have access to the same random access memory, allowing the processing workload to be switched between big and little cores. This architecture allows multi-core processing that adjusts computing power to dynamic workloads. The big CPUs are intended for high-level user-facing applications or high-level autonomous driving applications that integrate multi-function control such as sensing, map and localization, path planning, etc. The LITTLE CPU cores are intended for controlling small tasks.

For controlling the real-time sensing pipeline, several multi-threading reduced instruction set five (RISC-V) real-time controllers are deployed. The RISC-V controllers may execute multiple control threads concurrently. The control threads manage real-time task handling for specific sensing pipeline stages. The threads are synchronized using an event synchronization scheme.

This architecture utilizes dedicated hardware engines optimized for specific computation algorithms, including hardware image signal processors, pipeline functions, HDR, de-mosaic, tone mapping, de-noise, warping and computer vision functions such as stereo vision, optical flow and neural network processing functions for various layer types. The architectural philosophy depicted in this disclosure seamlessly combines various computation resources to maximize efficiency. The multi-threading RISC-V controllers play a critical role for real-time computation task scheduling. By using this architecture, each of the computation function essentially becomes a self-contained sub-system.

Similarly, in one example, real-time safety critical control tasks are handled by a dedicated safety sub-system with two ARM R-class real-time CPUs executing in lock-step to provide redundancy.

Multi-Level Memory Hierarchy

The disclosed architecture deploys a multi-level memory hierarchy to provide memory bandwidth for localized processing and minimized power consumption by reducing access frequency of global memories, especially for off-chip random access memory. In one example, to address the highly parallel processing and memory needs of a neural network, five levels of memory are deployed.

Random access memory is shared by the chip, the block tensor memory BTMEM is shared by the composite Net engine, the data buffer (DBUF) is shared by multiple sub-modules and arrays, the input buffer (IBUF), weight buffer (WBUF) and output buffer (OBUF) are shared jointly by the multiplier accumulator (MAC) array and local register and accumulators in the multiplier accumulator (MAC) cells.

The nearer the data is to computational elements, the higher frequency and bandwidth of memory access. The further away the data is from the computational elements, the more capacity may be provided.

In addition to memory hierarchy for hardware, multiple cache and local RAMs are also configured for the CPUs. The ARM A-class CPUs use two-level on-chip cache, L1 caches are dedicated to the cores and L2 caches are shared by cores of the same cluster. Real-time CPUs like ARM R-class safety CPU or RISC-V controllers use a combination of L1 caches and tightly coupled memories. The tightly-coupled memories allow real-time tasks to be more deterministic.

Multi-Tier Bus Hierarchy

The disclosed architecture deploys different network-on-chips (NOCs) to partition the logic into multiple bus hierarchy and sub-systems. The memory controller uses multiple ports to connect different NOCs for segregating memory access traffic in order to achieve better quality of service (QoS). Central processing units (CPUs) and graphics processing units (GPUs) are connected to a low-latency cache coherent NOC running at very high speed. The SoC is connected to a scalable System NOC to share bandwidth distribution and routing in order to achieve high speed. The sensing pipeline modules are connecting directly to the memory controller for high-priority low-latency real-time access, and the safety CPU and safety peripherals are connected to a separate Safety NOC for isolation and protection.

The combination of multi-tier bus hierarchy and multi-port memory controller may provide effective separation of the different local and global traffic types. These memory traffic types include latency sensitive, burst bandwidth traffic; real-time, high bandwidth traffic; latency sensitive, low bandwidth traffic and best effort, bulky bandwidth traffic.

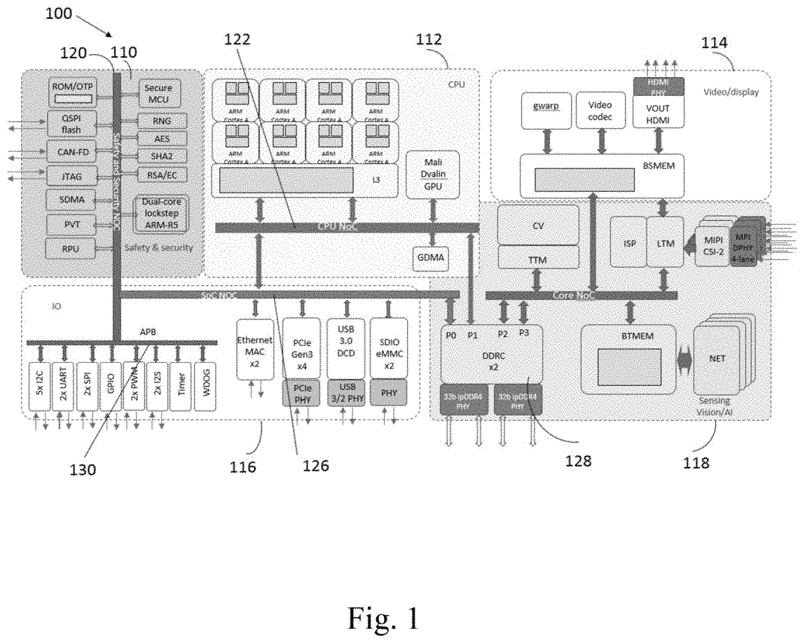

FIG. 1 depicts an example architecture having a series of domains, a safety and security domain 110, a CPU domain 112, a video display domain 114, an input output (IO) domain 116 and a sensing vision AI domain 118.

The domains of FIG. 1 are connected to memory either directly or through a series of networks on chip (NOC). The safety and security domain 110 are connected to a safety network on chip 120 for isolation and protection. The CPU domain 112 containing CPUs/GPUs is connected to a low-latency cache coherent network on chip (NOC) 122 running at very high speed. The video display domain 114 is connected to the memory controller 128 via bit stream memory and bit test memory. The IO domain 116 is connected to a scalable system SoC network on chip (NOC) 126 to share bandwidth distribution and routing. The sensing vision AI domain 118 is connected directly to the memory controller 128 for high-priority, low-latency real-time access. The safety NOC 120 is connected directly to the advanced peripheral bus 130 in the IO domain 116 and is connected to the system NOC 126 within the IO domain 116. The coherent NOC 122 in the CPU domain 112 is connected directly to the memory controller 128 in the sensing vision AI domain 118 and is connected to the system NOC 126 in the IO domain 116. The memories and processors in the sensing vision AI domain 118 are connected directly to the memory controller 128. In this way the various NOCs and the sensing vision AI domain are connected through the memory controller in a multi-tier hierarchy to multi-level memory.

The safety NOC 120 in the safety and security domain 110 may be connected to at least one of the following types of systems. Read only memory (ROM)/one time programmable (OTP), may provide memory that may be read at high speed, but may be programmed only once. Quad serial peripheral interface (QSPI) flash may provide an interface bus to connect a high-speed NOR flash device using 4 serial pins, which significantly increases data transfer throughput. Controller area network with flexible data-rate (CAN-FD) may provide a transmission protocol for automotive data downloads, in CAN-FD during transmission the bit rate may be increased due to the fact that no other nodes need to be synchronized. Joint test action group (JTAG) may provide an interface for testing circuit boards utilizing a dedicated serial debug port to attain low overhead access. System direct memory access (SDMA) is a controller that may serve as a global data transfer agent to handle various data transfer demands from software, such as memory-to-memory data copy. Performance verification test (PVT) is a performance test that outputs performance indicators. Resource protection unit (RPU) provides firewall protection of safety and security and keep critical interface or resource from being accessed by non-safety/security critical application code. Secure microprocessor control unit (MCU) may provide a small secure computer. Random number generator (RNG) provides true random number resources to secure firmware and secure applications. Advanced encryption standard (AES) is a cryptographic cypher. Secure hash algorithm 2 (SHA2) are cryptographic hash functions. Rivest, Shamir, and Adelman (RSA)/elliptic curve (EC) are public-key cryptography methods, EC being based on the algebraic structure of elliptic curves. In addition the safety and security NOC may be connected to multiple processors such as ARMs and the like.

The coherent NOC 122 in the CPU domain 112 may be connected to ARM processors, their L2 cache and GPUs.

The video display domain 114 may have the following couplings. High definition multimedia interface (HDMI) physical layer (PHY) allows transmission of uncompressed video data and digital audio data. Video out (VOUT) high definition multimedia interface (HDMI) may provide transmission of uncompressed video data. Video compression decompression module (CODEC) compresses data for transmission and decompresses received data.

The video sensing AI domain 118 may have the following components and connections within the domain. Block streaming memory (BSMEM) is the storage of a binary sequence of bits. Virtual instrument (VIN) virtualizes a channel stream and implements the functions of a virtual instrument by computer, sensors and actuators. Mobile industry processor interface (MIPI) camera serial interface 2 (CSI-2) is a high-speed protocol for point-to-point image and video transmission between cameras and host devices. Computer vision (CV) extracts, analyzes and determines information from video. Image signal processor (ISP) is a specialized digital signal processor (DSP) used in image analysis. Block tensor memory (BTMEM) is a type of high speed memory. NET is a neural net processor. Dual data rate memory controller (DDRC) is a random access memory controller. Thirty two bit (32b) double data rate fourth-generation synchronous dynamic random-access memory (DDR4) physical layer (PHY) is a type of synchronous dynamic random-access memory (SDRAM) with a high bandwidth (double data rate (DDR)) interface.

The IO domain 116 system NOC 126 may have at least one of the following connections. Advanced peripheral bus (APB) 130 may provide management of functional blocks in multi-processor systems with multiple controllers and peripherals. Inter integrated circuit (I2C) may provide a two-wire interface to connect low-speed devices. Universal asynchronous receiver transmitter (UART) may provide asynchronous serial communication in which the data format and transmission speeds are reconfigurable. Serial peripheral interface (SPI) may provide a synchronous serial communication interface for short distance communication. General purpose input output (GPIO) may provide an uncommitted digital signal pin whose behavior is run-time configurable. Pulse width modulation (PWM) emulates an analog output with a digital signal utilizing modulation, involving turning a square wave on and off. This modulation technique allows the precise control of power. Integer IC sound (I2S) may provide a serial bus interface for coupling digital audio devices. Watchdog (WDOG) timers generate a system reset if a main program does not poll it. It may automatically reset a device that hangs as the result of a fault. Ethernet medium access control (MAC) may provide a logical link layer that may provide flow control and multiplexing. Peripheral component interconnect express generation 3 (PCIe Gen3) to physical layer (PHY) may provide a high-speed serial expansion bus. Universal serial bus (USB) 3.0 dynamic content delivery (DCD)-universal serial bus physical layer (USB PHY) may provide an interface for computers and electronic devices, where the content may be delivered over an active channel, and then the channel may be inactivated or suspended depending on system needs. Secure digital card input output (SDIO) may provide a flash based removable memory card and embedded multimedia controller (eMMC) may provide a storage device made up of not and (NAND) flash memory and a storage controller. The IO domain may also include a timer input.

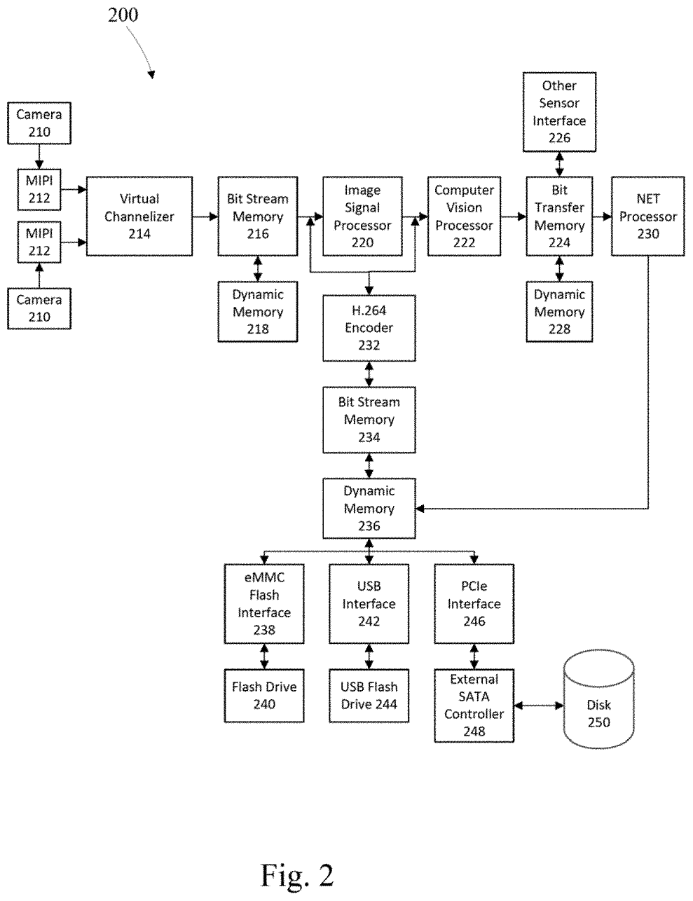

FIG. 2 depicts a second example system architecture. Cameras 210 receive a video feed that is routed to MIPI interfaces 212 that is routed to video input channelizer (VIN) 214 that performs de-interleaving of the video streams. The purpose of the virtual channels is to provide separate channels for different data flows that are interleaved in a data stream. A receiver monitors a virtual channel identifier and de-multiplexes the interleaved streams to their appropriate channel, allowing efficient buffer management. The video input channelizer 214 is connected to a bit stream memory 216 that is coupled to a random access memory 218. The bit stream memory 216 is connected to an image signal processor 220 and an encoder 232. The image signal processor may provide at least one of high dynamic resolution merging, de-mosaicing, tone mapping and white balancing, de-noising, sharpening, compression, scaling and color conversion. The image signal processor 220 is connected to computer vision processor 222. The computer vision processor 222 may provide at least one of warping, stereo vision and optical flow. The computer vision processor 222 is connected to bit transfer memory 224, which in turn is connected to other sensor interfaces 226, random memory 228 and a neural net processor 230. The neural net processor 230 may provide at least one of classification, object identification, free space recognition, segmentation and sensor fusion. The encoder 232 is connected to bit stream memory 234 and random access memory 236. The random access memory 236 is connected to the neural net processor 230 and eMMC flash memory interface 238, USB interface 242 and PCIe interface 246. The eMMC flash memory interface 238 is connected to flash drive 240. The USB interface 242 is connected to a USB flash drive 244 and PCIe interface 246 is connected to an external serial advanced technology attachment (SATA) controller 248 which in turn is connected to external disk 250. Random access memories 218, 228 and 236 may be separate or integrated. Bit stream memories 216 and 234 may be separate or integrated.

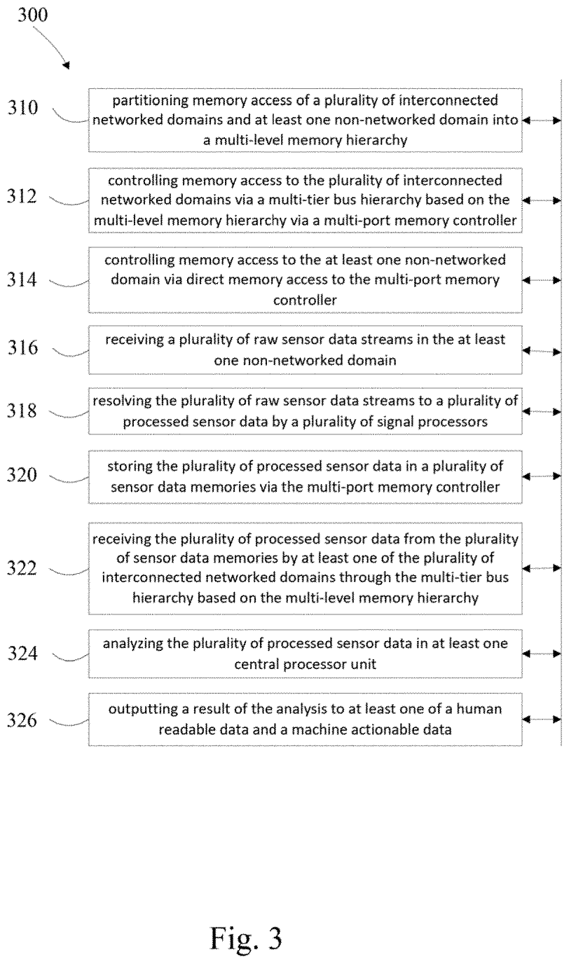

FIG. 3 depicts an example method of signal processing, including at least one of partitioning 310 memory access of a plurality of interconnected networked domains FIGS. 1, 110, 112 and 116 and at least one non-networked domain FIG. 1, 114 and 118 into a multi-level memory hierarchy. The chip is split into sub domains FIG. 1 110, 112, 114, 116 and 118 that control major sub systems of the overall design. In one example the domains would include a safety and security domain 110, a CPU domain FIG. 1, 112, a video display domain FIG. 1, 114, a sensing vision AI domain FIG. 1, 118 and an IO domain FIG. 1, 116. These domains have an associated bandwidth and speed. The method also includes controlling 312 memory access to the plurality of interconnected networked domains via a multi-tier bus hierarchy FIG. 1, 120, 122, 126 based on the multi-level memory hierarchy via a multi-port memory controller FIG. 1, 128. The multi-tier bus allows the domains to be connected to one another and to the multi-port bus. In this example the safety NOC FIG. 1, 120, coherent NOC FIG. 1, 122 and system NOC FIG. 1, 126 are connected to one other and the multi-bus memory controller FIG. 1, 128. The method includes controlling 314 memory access to the at least one non-networked domain, sensing vision AI domain FIG. 1, 118, via direct memory access to the multi-port memory controller FIG. 1, 128. The method also includes receiving 316 a plurality of raw sensor data streams, FIG. 2, cameras 210 and MIPI 212, in the at least one non-networked domain FIG. 1, 118. The raw sensor streams may comprise one of image data, light imaging and ranging (LIDAR) data, radio detection and ranging (RADAR) data, infrared data, audio data and the like. The method then includes resolving 318 the plurality of raw sensor data streams to a plurality of processed sensor data by a plurality of signal processors, in one example shown in FIG. 2, image signal processor 220, computer vision processor 222 and neural net processor 230. The method further includes storing 320 the plurality of processed sensor data in a plurality of sensor data memories FIG. 2, bit transfer memory 224, via the multi-port memory controller FIG. 1, 128, receiving 322 the plurality of processed sensor data from the plurality of sensor data memories by at least one of the plurality of interconnected networked domains, FIG. 1, 110, 112 and 116, through the multi-tier bus hierarchy FIGS. 1, 120, 122, 126 and 130 based on the multi-level memory hierarchy. The method then includes analyzing 324 the plurality of processed sensor data in at least one central processor unit, FIG. 1 CPU domain 112 and outputting 326 the result of the analysis to at least one of a human readable data and a machine actionable data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art will be able to design and incorporate any one of the variety of mechanisms suitable for accomplishing the above described functionalities.

It is to be understood that the disclosure teaches just one example of the illustrative embodiment and that many variations of the invention can easily be devised by those skilled in the art after reading this disclosure and that the scope of then present invention is to be determined by the following claims.

What is claimed is:

1. A system on a chip, comprising:
a multi-port memory controller having a multi-level memory hierarchy;
a multi-tier bus coupled to the multi-port memory controller to segregate memory access traffic based on the multi-level memory hierarchy;
an interconnected plurality of networks on chip coupled to the multi-tier bus;
a plurality of networked domains coupled to the plurality of networks on chip; and
at least one non-networked domain coupled directly to the multi-port memory controller.

2. The system of the chip of claim 1, wherein at least one of the plurality of networked domains includes at least one of a CPU and a GPU.

3. The system of the chip of claim 1, wherein the at least one non-networked domain includes at least one of a net engine, an image signal processor and a computer vision processor.

4. The system of the chip of claim 1, wherein the at least one non-networked domain includes at least a bit stream memory.

5. The system of the chip of claim 1, wherein at least one of the networked domains includes at least one of a safety and security domain, a CPU domain, a video display domain and an input output domain.

6. A system on a chip, comprising:
a multi-port memory controller;
a multi-tier bus coupled to the multi-port memory controller utilizing a multi-level memory hierarchy;
a plurality of interconnected networked domains coupled to the multi-tier bus, wherein memory access to the plurality of interconnected networked domains is controlled via a multi-tier bus hierarchy based on the multi-level memory hierarchy via the multi-port memory controller;
at least one non-networked domain directly connected to the multi-port memory controller, the at least one non-networked domain receives a plurality of raw sensor data streams in the at least one non-networked domain;
a plurality of signal processors that resolves the plurality of raw sensor data streams into a plurality of processed sensor data;
at least one sensor data memory that stores the plurality of processed sensor data via the multi-port memory controller;
at least one central processor unit that analyzes the plurality of processed sensor data;
at least one central data memory that stores at least one result of the analysis via the multi-tier bus hierarchy based on the multi-level memory hierarchy; and
an output interface that outputs the at least one result of the analysis in at least one of a human readable data and a machine actionable data.

7. The system on the chip of claim 6, wherein at least one of the plurality of signal processors is an ARM processor.

8. The system on the chip of claim 6, wherein at least one of the at least one central processor is a RISC processor.

9. The system on the chip of claim 6, wherein at least one of the plurality of signal processors is one of a central processing unit, a digital signal processor, and a dedicated hardware processing engine.

10. The system on the chip of claim 6, further comprising at least one random access memory controller coupled to at least one of the plurality of signal processors and at least one random access memory coupled to the at least one random access memory controller.

11. The system on the chip of claim 6, further comprising at least one direct memory access coupled to at least one of the plurality of signal processors, at least one random access memory controller coupled to the at least one direct memory access and at least one random access memory coupled to the at least one random access memory controller.

12. The system on the chip of claim 6, further comprising at least one storage controller coupled to at least one of the at least one central processor and at least one flash memory coupled to at least one storage controller.

13. The system on the chip of claim 6, wherein at least one of the raw sensor data streams comprise at least one of image data, lidar data, radar data, infrared data and audio data.

14. The system on the chip of claim 6, wherein at least two of the multi-tier buses are heterogeneous.

15. The system on the chip of claim 6, wherein at least one of the plurality of signal processors and the at least one central processor unit are heterogeneous.

16. The system on the chip of claim 6, wherein the plurality of sensor data memories and the at least one central data memory form the multi-level memory hierarchy.

17. A method of signal processing, comprising:
partitioning memory access of a plurality of interconnected networked domains and at least one non-networked domain into a multi-level memory hierarchy;
controlling memory access to the plurality of interconnected networked domains via a multi-tier bus hierarchy based on the multi-level memory hierarchy via a multi-port memory controller;
controlling memory access to the at least one non-networked domain via direct memory access to the multi-port memory controller;
receiving a plurality of raw sensor data streams in the at least one non-networked domain;
resolving the plurality of raw sensor data streams to a plurality of processed sensor data by a plurality of signal processors;
storing the plurality of processed sensor data in a plurality of sensor data memories via the multi-port memory controller;
receiving the plurality of processed sensor data from the plurality of sensor data memories by at least one of the plurality of interconnected networked domains through the multi-tier bus hierarchy based on the multi-level memory hierarchy;
analyzing the plurality of processed sensor data in at least one central processor unit; and
outputting a result of the analysis to at least one of a human readable data and a machine actionable data.

18. The method of signal processing of claim 17, wherein the storing of the plurality of processed sensor data utilizes a bit stream memory.

19. The method of signal processing of claim 17, wherein the resolving the plurality of raw sensor data streams and the analyzing of the plurality of processed sensor data are heterogeneous.

20. The method of signal processing of claim 17, wherein controlling memory access to the at least one non-networked domain via direct memory access to the multi-port memory controller is performed utilizing a wider total bandwidth than a controlling memory access to the plurality of interconnected networked domains.
